(19) United States
(12) Patent Application Publication
(10) Pub. No.: US 2022/0355584 A1
(43) Pub. Date: Nov. 10, 2022

(54) ULTRA LOW HEAT BUILDUP CAPSTOCK

(71) Applicant: Arkema France, King of Prussia, PA (US)

(72) Inventors: Jing-Han Wang, King of Prussia, PA (US); Ronson Lamond, Pendel, PA (US)

(73) Assignee: Arkema France, King of Prussia, PA (US)

(21) Appl. No.: 17/623,483

(22) PCT Filed: Jun. 22, 2020
(86) PCT No.: PCT/US2020/038935

§ 371 Date: Dec. 28, 2021

Related U.S. Application Data
(60) Provisional application No. 62/867,918, filed on Jun. 28, 2019.

(51) Int. Cl. B32B 27/20; B32B 7/027; B32B 7/10; B32B 27/08; B32B 27/30; B32B 37/15

(52) U.S. Cl. CPC B32B 27/20; B32B 7/027; B32B 7/10; B32B 27/08; B32B 27/308; B32B 37/153; B32B 2250/02; B32B 2250/24; B32B 2255/10; B32B 2255/20; B32B 2264/1022; B32B 2307/306; B32B 2307/41; B32B 2307/416; B32B 2307/4026; B32B 2307/42; B32B 2307/422; B32B 2307/732

(57) ABSTRACT

The invention relates to a dark thermoplastic polymer composition, which when formed into a film has an ultra-low heat buildup, is visibly opaque, and has a high NIR transmission. The dye system involves two or more IR transparent dyes that combine to produce a color having an L value of less than 40, preferably less than 30, and a heat buildup of less than 50° F., preferably less than 45° F. In one embodiment, the composition is jet black. The composition may be a free-standing film, or a capstock used over a substrate, preferably a white substrate.

### FIELD OF THE INVENTION

The invention relates to a dark colored thermoplastic polymer composition, which when formed into a film has an ultra-low heat buildup when extruded or laminated over light colored substrates, is visibly opaque, and has a high NIR transmission. The colorant system involves two or more IR transparent dyes that combine to produce a color having an L value of less than 40, preferably less than 30, and a heat buildup of less than 50° F., preferably less than 45° F. In one embodiment, the composition is jet black. The composition may be a free-standing film, or as a capstock used over a substrate, preferably a white substrate.

### BACKGROUND OF THE INVENTION

Many structural plastics exhibit attractive mechanical properties when extruded, molded, or formed into various articles of manufacture. Such articles include, for example, sporting and recreational equipment, decorative exterior trim, molding side trim, quarter panel trim panels, fender and fender extensions, louvers, rear end panels, caps for pickup truck back, rearview mirror housings, accessories for trucks, buses, campers, vans, and mass transit vehicles, b pillar extensions, and the like, bathtubs, shower stalls, counters, appliance housings and liners, building materials, doors, windows, siding, decking, railings and shutters, lawn and garden applications, marine applications, aerospace application, pool application, and storage facilities. Although these structural plastics are strong, tough and relatively inexpensive, the properties of their exposed surfaces are less than ideal. That is, the surfaces of the structural plastics are degraded by light; they can be easily scratched, and can be eroded by common solvents.

Consequently, it has become a practice in the industry to apply another resinous material over the structural plastic to protect the underlying structural material and provide a surface that can withstand abuse associated with the use environment. Such surfacing materials are called “capstocks”.

The capstock generally is much thinner than the structural plastic, typically being about 5 to about 25% of the total thickness of the multilayer structure comprising the capstock and structural plastic plies. For example, the thickness of the capstock can be about 0.025 to about 2.5 mm, whereas the thickness of the structural plastic ply can be about 1.0 to about 50 mm, and preferably 2.5 to 30 mm.

Dark capstocks, such as dark red, dark green, dark grey and even jet black are often desired in sidings, handrails, decks, and framings for windows and doors. The problem with dark colored capstock is that they have a high heat buildup. High heat buildup can lead to warping of the underlying substrate—such as PVC substrates often used in window and door framing.

U.S. Pat. No. 8,632,868, US 2006/0255496 and 2017/0361517 describe three factors affecting, that the level of heat buildup in a dark capped substrate. 1) The thickness of the dark-colored capstock should be selected to minimize IR absorbance as NIR passes through the dark-colored capstock and as it is reflected off of the substrate back through the dark-colored capstock. This selection must be done in a manner that preserves the visual color of the capstock. 2) The substrate is selected to provide the IR reflectance, most commonly by manipulating the loading of TiO₂, and 3) the pigments in the dark-colored capstock required to impart particular colors should be optimized to minimize their absorbance of NIR. In practice, all three means must be optimized for a particular capstock/color/substrate combination to yield a functional final product. These references show that a dark color, such as Hunter green and bronze, with a L value range of 13 to 40 can be achieved having a heat buildup of less than 58° F. and even less than 52° F., using an IR transparent dye including a black base colorant, in a thin cap layer, and an IR reflective substrate having a high level of TiO₂.

Problem: There is a need to provide visibly opaque, dark colored, multi-layered structures, having an L value of less than 50, less than 40, less than 30, less than 25, such as jet black with a low heat buildup temperature. There is also a desire to provide these as dark colored capstock films and multi-layered structures that produce heat buildup of less than 55° F., and even down to 45° F., 42° F. and below.

Solution: It has now been found that by using a combination of two or more IR transparent dyes, and especially combinations having little or no black dyes or pigments, a dark, visibly opaque capstock covered white substrate can be provided having heat buildups of less than 55° F., less than 50° F., less than 45° F. and even less than 42° F. The colors can have low L values of less than 50, less than 40, less than 30, and even less than 25, including jet black.

### SUMMARY OF THE INVENTION

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Aspects of the Invention Include:

In a first aspect, a dark-colored polymer composition contains a) a thermoplastic polar polymer matrix; b) 0.01 to 1.2 weight percent total of two or more dyes, based on the weight of the polymer matrix, where said dyes are thermally stable, having a sublime temperature greater than 200° C., and preferably greater than 210° C.; wherein said composition meets all of the following conditions when formed into a monolayer film of 0.254 mm: 1) an L value of less than 50, preferably less than 40, more preferably less than 30, more preferably less than 25, 2) is opaque to visible light; 3) a heat buildup temperature of less than 55° F., preferably less than 50° F., preferably less than 48° F., preferably less than 46° F., preferably less than 44° F., and preferably less than 42° F. 4) an NIR transmission at 800 nm of greater than 60 percent, preferably greater than 70%, and more preferably greater than 80%.

In a second aspect, the dark-colored polymer composition of aspect 1 involves the thermoplastic polar polymer being selected from the group consisting of acrylic-based polymers, styrenic-based polymers, polyesters, polycarbonate, polyvinylidene fluoride (PVDF), polyamide, and thermoplastic polyurethane (TPU), and preferably one or more acrylic-based polymers.

In a third aspect, the dyes in any of aspects 1 or 2 when added to an acrylic resin matrix at a loading of at least 0.2% and at a thickness of at least 0.12 mm have a high transmittance at 800 nm of greater than 80 percent, preferably greater than 85 percent, and preferably greater than 90 percent. The dye loading is related to thickness, when doing this test at a thickness of 5-6 mils (0.127-0.15 mm) at least 0.2% dye is needed.

In a fourth aspect, the dark-colored polymer composition of any of the previous aspects, is jet black, having an L value between 20 and 30, preferably from 23 to 25, and where the heat buildup is less than 48° F., preferably less than 46° F., more preferably less than 44° F.

In a fifth aspect, a multi-layer, dark-colored structure comprises from the outside to the inside:

a) an outer cap stock layer comprising at least one thermoplastic polar polymer matrix polymer, and at least 0.01 to 1.2 total weight percent based on the matrix polymer of two or more dyes, wherein said cap stock layer is opaque to visible light; and has a transmission at 800 nm of greater than 60 percent, preferably greater than 70%, and more preferably greater than 80%, and wherein said cap layer has an L value of less than 50, preferably less than 40, more preferably less than 30, more preferably less than 25; and

b) an NIR reflective substrate layer,

where the heat buildup temperature of the multilayer structure is less than 55° F., preferably less than 50° F., preferably less than 48° F., preferably less than 46° F., preferably less than 44° F., and preferably less than 42° F.

In a sixth aspect, the multi-layer dark-colored structure of aspect 5, has a thermoplastic polar polymer selected from the group consisting of acrylic-based polymers, styrenic-based polymers, polyesters, polycarbonate, polyvinylidene fluoride (PVDF), and thermoplastic polyurethane (TPU), and preferably being acrylic-based polymers.

In a seventh aspect, the dyes in the multi-layer dark-colored structure of aspects 5 or 6, when added to an acrylic resin matrix have a transmittance at 800 nm for a minimum of 0.2% dye concentration at a minimum of 0.12 mm in thickness in an acrylic matrix polymer of greater than 80 percent, preferably greater than 85 percent, and preferably greater than 90 percent.

In an eighth aspect, the multi-layer dark-colored structure of any of aspects 5 to 7 is jet black, wherein said L value is between 20 and 30, preferably from 23 to 25, and wherein said heat buildup is less than 48° F., preferably less than 46° F., more preferably less than 44° F.

In a ninth aspect, the multilayer, dark-colored structure of any of aspects 5 to 8, has an IR reflective substrate selected from the group consisting of polystyrene (PS), high impact polystyrene (HIPS), acrylonitrile/butadiene/styrene (ABS), styrene/butadiene or styrene/isoprene (SBS/SIS), hydrogenated SBS/SIS, polyolefin derivatives such as polypropylene, polyethylene, thermoplastic polyolefin copolymers, polyvinyl chloride (PVC), wood polymer composites, biopolymers, pultruded polyester or polyurethane composites

In a tenth aspect, the multilayer, dark-colored structure of any of aspects 5 to 9 involves a structure that further contains an intermediate high NIR reflective layer between the cap layer and the substrate layer, wherein said high NIR reflective layer comprises at least 6 weight percent of titanium dioxide.

In an eleventh aspect, a process for forming the multilayer structure of any of aspects 5 to 10, involves the steps of:

a) blending the components of the cap layer together,

b) applying said cap layer composition onto a substrate layer.

In a twelfth aspect, the process of aspect 11 is a coextrusion, injection molding, insert molding, pultrusion, or extrusion lamination.

In a thirteenth aspect, the process of any of aspects 11 or 12, includes prior to step a) at least two different master batches being formed, each containing one or more dyes and a thermoplastic carrier resin, followed by combining the master batches with the matrix resin.

In a fourteenth aspect the multilayer, dark colored structure of any of claims 5 to 10, or formed by the process of any of claims 11 to 13, is an article selected from the group consisting of: automotive parts, recreational vehicles, bathtubs, shower stalls, counters, appliance housings and liners, building materials, doors, windows, siding, decking, railings, shutters, lawn and garden parts, storage containers, deck board, hand rail siding, and window profiles.

### DESCRIPTION OF THE DRAWINGS

FIG. 1 shows the transmission data of three polymeric film samples of Example 2.

### DETAILED DESCRIPTION OF THE INVENTION

The invention relates to a dark thermoplastic polymer composition, in which a film formed from the composition is opaque to visible light, has an L value of less than 50 and a heat buildup of less than 55° F.

All references cited herein are incorporated by reference. Unless otherwise stated, all molecular weights are weight average molecular weights as determined by Gas Permeation Chromatography (GPC), and all percentages are percentage by weight.

The term “copolymer” as used herein indicates a polymer composed of two or more different monomer units, including two comonomers, terpolymers, and polymers having 3 or more different monomers. The copolymers may be random or block, may be heterogeneous or homogeneous, and may be synthesized by a batch, semi-batch or continuous process.

### Thermoplastic Polymer Matrix

The thermoplastic polymer of the composition which forms the composition matrix may be any thermoplastic polymer, or compatible mixture thereof. Preferably the polymer(s) are polar.

The polar polymer may be used without any additives, thereby making up over 97 percent of the outer layer, with the colorants making up the remainder. In the polar polymer matrix, more than 50 weight percent of the matrix polymer is polar polymers, preferably at least 70 weight percent, more preferably at least 85 weight percent, and even including a matrix in which the polymer is 100 weight percent of one or more polar polymers. Useful polar polymers include, but are not limited to acrylic-based polymers, styrenic-based polymers, polyesters, polycarbonate, polyvinylidene fluoride (PVDF), and thermoplastic polyurethane (TPU), or compatible mixtures thereof. Preferred thermoplastic polar polymers are acrylic or styrenic-based polymers. A preferred polar polymer for the matrix is one or more acrylic polymer(s) or copolymer(s).

Acrylic-based polymers, as used herein, is meant to include polymers, copolymers and terpolymers formed from alkyl methacrylate and alkyl acrylate monomers, and mixtures thereof. The alkyl methacrylate monomer is preferably methyl methacrylate, which may make up from greater than 50 to 100 weight percent of the monomer mixture, preferably at least 70 weight percent, and more preferably at least 80 weight percent. 0 to 50 percent of other acrylate and methacrylate monomers or other ethylenically unsaturated monomers, included but not limited to, styrene, alpha methyl styrene, acrylonitrile, and crosslinkers at low levels may also be present in the monomer mixture. Suitable acrylate and methacrylate comonomers include, but are not limited to, methyl acrylate, ethyl acrylate and ethyl methacrylate, butyl acrylate and butyl methacrylate, iso-octyl methacrylate and iso-octyl acrylate, lauryl acrylate and lauryl methacrylate, stearyl acrylate and stearyl methacrylate, isobornyl acrylate and isobornyl methacrylate, methoxy ethyl acrylate and methoxy methacrylate, 2-ethoxy ethyl acrylate and 2-ethoxy ethyl methacrylate, and dimethylamino ethyl acrylate and dimethylamino ethyl methacrylate monomers. Alkyl (meth) acrylic acids such as methacrylic acid and acrylic acid can be useful for the monomer mixture, at levels up to 10 weight percent of the total polymer. Most preferably the acrylic polymer is a copolymer having 70-99.5 weight percent of methyl methacrylate units and from 0.5 to 30 weight percent of one or more C₁₋₈ straight or branched alkyl acrylate units.

Styrenic-based polymers include, but are not limited to, polystyrene, high-impact polystyrene (HIPS), acrylonitrile-butadiene-styrene (ABS) copolymers, acrylonitrile-styrene-acrylate (ASA) copolymers, styrene acrylonitrile (SAN) copolymers, methacrylate-butadiene-styrene (MBS) copolymers, styrene-butadiene copolymers, styrene-butadiene-styrene block (SBS) copolymers and their partially or fully hydrogenenated derivatives, styrene-isoprene copolymers, styrene-isoprene-styrene (SIS) block copolymers and their partially or fully hydrogenenated derivatives, and styrene-(meth)acrylate copolymers such as styrene-methyl methacrylate copolymers (S/MMA). A preferred styrenic polymer is ASA. The styrenic polymers of the invention can be manufactured by means known in the art, including emulsion polymerization, solution polymerization, and suspension polymerization. Styrenic copolymers of the invention have a styrene content of at least 10 percent by weight, preferably at least 25 percent by weight.

In one embodiment, the polar polymer has a weight average molecular weight of between 50,000 and 500,000 g/mol, and preferably from 75,000 and 200,000 g/mol, as measured by gel permeation chromatography (GPC). The molecular weight distribution of the acrylic polymer may be monomodal, or multimodal with a polydispersity index greater than 1.5. In a preferred embodiment the polar polymer has a T_{g} of greater than 70° C.

In a preferred embodiment, the thermoplastic polymer composition is formed into a film that is at the same time NIR transmissive, optically opaque, an L value of less than 50, and has a heat buildup of less than 50° F. By NIR transmissive is meant that greater than 60 percent, more preferably at least 70 percent, and more preferably at least 80 percent of near infrared radiation measured at 800 nm is transmitted through the film. Near infrared radiation is that in the 0.7 to 5 micron wavelength range, and the percent transmission at 800 nm is measured by ASTM E1164 in the form of a 0.127 mm film with at least 0.2% dye colorants (or enough colorants to make an opaque film). . By optically opaque, is meant that the contrast ratio of the film, as measured on an X-Rite Color i7. The luminous reflectance (Y) is measured for a sample film over a white substrate and black substrate. The resulting ratio is then calculated, Y over black/Y over white. This value should be >98%, and preferably greater than 99%. If the contrast ratio of below 98%, the substrate will show through, and the film is not optically opaque.

The desired properties of opaqueness and NIR transmittance of a film of the inventive composition result from a balance of the film thickness and the concentration of the colorant. In order to achieve this balance, the film thickness of the invention will be in the range of 0.1 to 0.5 mm, and preferably 0.127 to 0.381 mm. A higher level of dye will allow a thinner film to exhibit opaqueness. Yet if the film is too thin, the large increase in the level of dye will overwhelm the composition, and likely lead to processing issues, such as pooling of the colorant dyes, and defects in the film. If the film is too thick, it will be difficult to maintain the needed NIR transmission.

### Additives

The composition of the invention, in addition to having a polar polymer matrix and at least two colorants, may contain additives typically found in a capstock composition. Non-limiting examples of such additives include fillers, impact modifiers, surface modifying additives, flame retardants, antioxidants, UV screening additives, thermal stabilizers, and processing aids. Examples of fillers employed include talc, calcium carbonate, mica, matting agents, wollastonite, dolomite, glass fibers, boron fibers, carbon fibers, carbon blacks, pigments such as titanium dioxide, or mixtures thereof. Other polymer additives could include polycarbonates, polyurethanes, polysulfones, polyamides, polyolefin including copolymers and terpolymers based on these polymers, and including linear, branched, block, and grafted polymer structures. Impact modifiers include core-shell and block copolymer impact modifiers. Examples of matting agents include, but are not limited to, cross-linked polymer particles of various geometries. The amount of filler and additives included in the polymer compositions of each layer may vary from about 0.01% to about 70% of the combined weight of polymer, additives and filler. Generally, amounts from about 5% to about 60%, from about 10% to about 50%, are included. In a preferred embodiment, impact modifiers are expected to be the largest contributor to any added filler, with impact modifiers used having little to no effect on NIR transparency. Antioxidants as are commonly known in the art are suitable to add to the polymers described herein at any suitable level. Non-limiting examples include sterically hindered phenols, organophosphites and amines. Additives as are commonly known in the art to improve and enhance UV stability are suitable to use at any suitable level in any of the layers for the multilayer composite structure. Non-limiting examples include hindered amine light stabilizers (HALS), benzotriazoles, triazines, benzophenones, and cyanoacrylates.

### Colorant

The composition of the invention has a dark color with an L value of less than 50, less than 40, less than 35, less than 30, less than 25. This need for a dark color must be balanced by a low heat buildup of less than less than 55° F., less than 50° F., less than 45° F. and even less than 42° F. Spectrometric data for specimens was generated using d−8° illumination according to ASTM E1164 with an X-Rite 7000A photospectrometer or PerkinElmer Lambda 950 scanning spectrometer. Color data, including L value, was then calculated using ASTM E308 and reported using CIE L*a*b* D65-10°.

The ultra-low heat buildup, dark color of films produced from the composition of the invention, is due to the dark color being formed from a combination of two or more NIR transmissive dyes. By NIR transmissive dyes is meant that a at least 0.2 weight percent dye composition in present in an acrylic resin in a form of 0.12 mm thick film has a transmission at 800 nm of greater than 80 percent, more preferably greater than 85 percent, and most preferably greater than 90 percent, as measured according to ASTM E 1164.

This differs from a carbon black pigment or metal oxide modified for IR reflection, as found in the art, which show a heat buildup of 57° F., 59° F. or more. The composition may contain any number of different dyes as long as at least two different dyes are present. This includes three, four, five and even six or more different dyes combined to form the desired final color.

In one embodiment, a black color, and even a jet black color was produced, having the low heat buildup. An L value of 20-30, and preferably 23-25 was obtained. This was possible using little or no black dye, at less than 10 wt %, less than 5 wt % less than 2 wt %, and most preferably at zero wt % of the total dye.

In one embodiment it was found that a blend of non-black dyes to form the dark, and even a black colored film, provides a lower heat buildup than dark colors based on a black dye. This is because the black dye absorbs more heat than any of the non-black dyes used in combination to produce an over-all dark color. While not being bound by any particular theory, it is believed that the reason samples containing IR transmissive black dyes exhibit higher heat buildup than samples containing multiple non-black IR transmissive colorants of the invention is that when measured against a white substrate, the overall IR reflectance of the black dye in the wavelength region from 690 nm to 2220 nm is lower compared to the colorants of the invention. This difference is especially profound between 690 nm to 1130 nm. The high IR reflectance of the colorants used in this invention over a white substrate leads to even lower heat buildup compared to black dyes over the same white substrate.

The level of dye used in the composition is a function of the thickness of the film, and the balance between optical opacity, NIR transmittance and heat buildup. In one embodiment the total level of dye of the total composition used in an injection molded part is in the range of from 0.01 to 1.2 weight percent, preferably from 0.05 to 0.5 weight percent, based on the total weight of the polymer matrix. Lower total levels of dye will not provide the needed opacity, and higher dye levels undesirably increase the cost of the composition. At total dye levels above 3 weight percent, processing issues arise, including dye pooling and surface defects.

The dyes of the invention are preferably NIR transmissive, and thermally stable. By thermally stable is meant that the dyes do not sublimate in the typical 160 to 200° C. process window for two minutes. Preferably each of the dyes used has a sublime temperature of greater than 200° C., preferably greater than 210° C., and more preferably greater than 220° C.

### Substrate

The dark thermoplastic polymer composition of the invention could be used as a mono-layer film. In a preferred embodiment the dark thermoplastic polymer composition is part of a multi-layer structure, as a thin capstock over a white substrate. The substrate can be pultruded, extruded, or otherwise formed into a profile.

In a preferred embodiment, the substrate is NIR reflective, meaning that greater than 50 percent, more preferably greater than 60 percent, and most preferably greater than 70 percent of NIR radiation at 800 nm is reflected from the surface. The percent reflectance can be measured using a Xrite 7000A phtospectrophotometer using d−8° illumination according to ASTM E1164 on the substrate or by itself.

In one embodiment, a separate, thin, high IR reflective layer is present between the cap layer and the substrate layer, for the purpose of providing a high IR reflectance. This high IR reflective layer could be a thermoplastic, a thermoset polymer, or a coated metal layer. The high IR reflecting layer, as described in US 2017/0361517 contains greater than 8 percent of titanium dioxide, based on the weight of the polymer resin.

In a preferred embodiment of the invention, an intermediate thin, high IR reflective layer is not needed, and the dark thermoplastic cap layer may be applied directly to the substrate layer. The elimination of an optional intermediate, high-IR reflectance layer saves manufacturing steps and costs.

The substrate layer is at least twice as thick as the capstock, preferably at least five times as thick. The substrate layer can be between 50 microns and 10 cm, preferably from 0.2 mm to 10 cm. The substrate may be another polymer (thermoplastic, elastomeric, or thermoset) such as non-limiting examples acrylic, polystyrene (PS), high impact polystyrene (HIPS), acrylonitrile/butadiene/styrene (ABS), styrene/butadiene or styrene/isoprene (SBS/SIS), hydrogenated SBS/SIS, polyolefin derivatives such as polypropylene, polyethylene, thermoplastic polyolefin copolymers, polyvinyl chloride (PVC), biopolymers, pultruded polyester or polyurethane composites, wood polymer composites; or can be a non-polymer material including, but not limited to paper, metal, ceramics, glass, wood etc.

Composite materials, such as an ASN/wood composite, a fiber-reinforced polymer composite, or a composite formed from a liquid resin system, such as an ELIUM® liquid resin system from Arkema, may also serve as the substrate.

### Process

The composition of the invention can be formed by blending the matrix thermoplastic polymer resin with the dyes and optional additives, by means known in the art. The components of the composition may be added in any order, and may be melt blended together. Since the level of colorant is very low, a preferred process involves first forming a master batch for each colorant, using a polar polymer carrier resin that is compatible with the matrix polymer, then melt blending the desired level of the masterbatch into the matrix polymer. In one embodiment, the carrier resin has a lower T_{g} than the matrix resin, which may provide better dispersion of the masterbatch into the matrix resin.

Once the matrix resin has been fully blended with the dyes of the invention, a mono-layer film may be produced by means typical in the art, such as extrusion and blow molding.

A multi-layer structure or profile, having the dark capstock of the invention can be formed by means known in the art, such as by coextrusion, injection molding, insert molding, pultrusion, and extrusion lamination.

In one specific embodiment, a multi-layer structure having a cap thickness of 0.254 mm, and the total structure thickness of 1.73 mm was produced.

The formed multi-layer structure can be provided in a sheet form, which is then thermoformed after formation, into useful multi-layer articles. The multi-layer structure may also be directly coextruded into a final profile or article. Useful capped articles of the invention include, but are not limited to, automotive parts, recreational vehicles, bathtubs, shower stalls, counters, appliance housings and liners, building materials, doors, windows, siding, decking, railings and shutters, lawn and garden parts, and storage containers. The multilayer structure could also be directly coextruded into a profile, such as, but not limited to, deck board, hand rail siding, and window profiles.

### Properties

The dark colored composition of the invention can be made into a mono-layer film that has an L value of less than 50, preferably less than 40, less than 35, and even less than 25, such as jet black; is optically opaque; and has a heat buildup of less than 55° F., less than 50° F., less than 48° F., less than 46° F., less than 44° F. and even less than 42° F. A jet black film having an L value of from 20 to 30, and preferably from 23-25, is NIR transmissive, and is optically opaque, can have a low heat buildup of less than 48° F., less than 46° F., less than 44° F. and even less than 42° F.

A multi-layer structure of the invention has a cap layer having a thickness of 0.1 to 0.5 mm, and preferably 0.13 to 0.38 mm. The cap layer is optically opaque, has an L value of preferably less than 40, less than 30, less than 25, and is NIR transmissive; and the whole multi-layer structure, including a white substrate layer, has a heat buildup of less than 55° F., less than 50° F., less than 48° F., less than 46° F., less than 44° F. and even less than 42° F.

### EXAMPLES

### Example 1

The following three capstock layer polymer blends were prepared, one comprising an ultralow heat buildup colorant package according to the invention, the second one comprising a competitive IR transmissive black colorant, and the third one comprising an IR reflective black pigment. A ⅛″ sample with carbon black in PVC was also prepared for comparison.

The acrylic cap formulation is prepared by melt-blending the components in a twin-screw extruder operating at 300-425 rpm with the typical processing temperatures listed below:

| Zone 1 | Zone 2 | Zone 3 | Zone 4 | Zone 5 | Zone 6 | Zone 7 | Zone 8 | Zone 9 | Die |
|---|---|---|---|---|---|---|---|---|---|
| 100° C. | 132° C. | 151° C. | 220° C. | 220° C. | 220° C. | 222° C. | 220° C. | 1382° C. | 260° C. |

The acrylic cap stock blends made were co-extruded over a white PVC substrate with a custom made 1″×4″ die and two extruders: a substrate layer extruder and a capstock layer extruder.

The white PVC substrate extruder was a single screw extruder operating at 8 revolutions per minute (RPM) with barrel temperature profile of 168° C. (feed end) to 182° C. (die end).

The acrylic blend cap stock layer extruder was a single-screw extruder with barrel temperature profile of 187° C. (feed) to 210° C. (die end). The co-extrusion die temperature for the profile was set at 168° C. and 185° C. The thickness of the acrylic cap can range from 0.001″ to 0.02″.

These acrylic compositions and their heat buildup and L values are shown in TABLE 1:

TABLE 1

| | Acrylic | Acrylic | Acrylic | PVC |
|---|---|---|---|---|
| | Capstock | Capstock | Capstock | sheet |
| | 1 (inven- | 2 (com- | 3 (com- | (com- |
| Ingredient | tion) | parative) | parative) | parative) |
| Acrylic polymer blend | 99.668 | 99 | 92 | |
| PVC polymer blend | | | | 98 |
| Solvent Red 195 | 0.157 | | | |
| Solvent Green 3 | 0.175 | | | |
| Lumogen ®FK4280 | | 1 | | |
| IR reflective black pigment | | | 8 | |
| Carbon black | | | | 2 |
| Vertical heat buildup (F) | 44 | 53 | 57 | 74 |
| L value (SPIN D65, 10°) | 23 | 25 | 26 | |

It's clear that the ultra low heat buildup colorant in Acrylic Capstock 1 represents the lowest heat buildup value (44F) and a L value of 23, while the comparative examples show higher heat buildup values (53F and 57F). This is likely due to the combination of a highly IR transmissive acrylic capstock layer and a highly IR reflective substrate layer (white PVC).

### Example 2

This example demonstrates the NIR transmissive nature of the dyes with the transmission data obtained from a spectrophotometer. The spectral data was generated using with a PerkinElmer Lambda 950 scanning photospectrometer using d−8° illumination according to ASTM E1164.

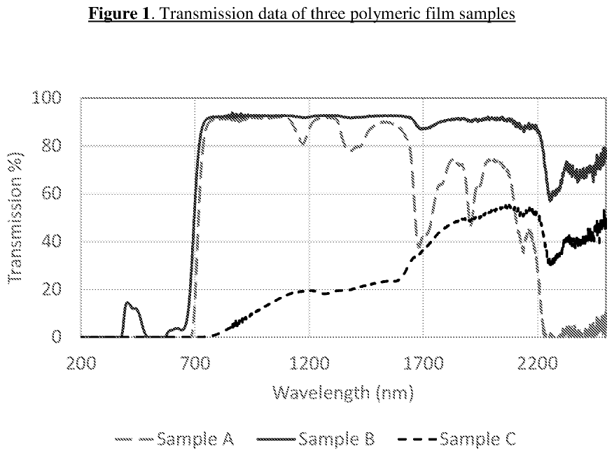

As shown in the FIG. 1, Sample A and Sample B both have more than 90% transmission at 800 nm because both samples contains a combination of high IR transmissive organic colorants. Sample C has much lower transmission at the same wavelength, and this sample contains an IR reflective pigment.

The composition of samples in this example are shown in TABLE 2:

TABLE 2

| Ingredient | Sample A | Sample B | Sample C |
|---|---|---|---|
| Acrylic polymer blend | 99.50 | 99.668 | 88 |
| PVDF polymer | | | 8 |
| Solvent Red 195 | | 0.157 | |
| Solvent Green 3 | 0.087 | 0.175 | |
| Solvent Red 111 | 0.418 | | |
| IR reflective black pigment | | | 4 |
| Transmittance at 800 nm | 91.02 | 91.96 | 1.28 |
| Thickness | 0.060” | 0.005” | 0.005” |
| L value (SPIN D65, 10°) | 23.7 | 23.2 | 26.6 |

What is claimed is:

1. A dark-colored polymer composition, wherein said composition comprises:
a) a thermoplastic polar polymer matrix;
b) 0.01 to 1.2 wt percent total of two or more dyes, based on the weight of the polymer matrix, wherein said dyes are thermally stable, having a sublime temperature greater than 200° C.;
wherein said composition meets all of the following conditions when formed into a monolayer film of 0.254 mm:
1) an L value of less than 50,
2) is opaque to visible light;
3) a heat buildup temperature of less than 55° F.,
4) an NIR transmission of greater than 80 percent, as measured according to ASTM E 1164.

2. The dark-colored polymer composition of claim 1, wherein said thermoplastic polar polymer comprises one or more polymers selected from the group consisting of acrylic-based polymers, styrenic-based polymers, polyesters, polycarbonate, polyvinylidene fluoride (PVDF), and thermoplastic polyurethane (TPU).

3. The dark-colored polymer composition of claim 1, wherein said thermoplastic polar polymer comprises one or more acrylic-based polymers.

4. The dark-colored polymer composition of claim 1, wherein the dyes when added to an acrylic resin matrix have a transmittance at 800 nm of greater than 80 percent.

5. The dark-colored polymer composition of claim 1, wherein said dark color is jet black, wherein said L value is between 20 and 30, and wherein said heat buildup is less than 48° F.

6. A multi-layer, dark-colored structure comprising from the outside to the inside:
a) an outer cap stock layer comprising at least one thermoplastic polar polymer matrix polymer, and at least 0.01 to 1.2 total weight percent based on the matrix polymer of two or more dyes, wherein said cap stock layer is opaque to visible light; and has an NIR transmission at 800 nm of greater than 60%, and wherein said cap layer has an L value of less than 50; and
b) an NIR reflective substrate layer,
wherein the heat buildup temperature of the multilayer structure is less than 55° F.

7. The multi-layer dark-colored structure of claim 6, wherein said thermoplastic polar polymer comprises one or more polymers selected from the group consisting of acrylic-based polymers, styrenic-based polymers, polyesters, polycarbonate, polyvinylidene fluoride (PVDF), and thermoplastic polyurethane (TPU).

8. The multi-layer dark-colored structure of claim 6, wherein said thermoplastic polar polymer comprises one or more acrylic-based polymers.

9. The multi-layer dark-colored structure of claim 6, wherein the dyes when added to an acrylic resin matrix at 0.2 weight percent have a transmittance at 800 nm of greater than 80 percent, as measured according to ASTM E 1164.

10. The multi-layer dark-colored structure of claim 6, wherein said dark color is jet black, wherein said L value is between 20 and 30, and wherein said heat buildup is less than 48° F.

11. The multilayer, dark-colored structure of claim 6, wherein said IR reflective substrate is selected from the group consisting of polystyrene (PS), high impact polystyrene (HIPS), acrylonitrile/butadiene/styrene (ABS), styrene/butadiene or styrene/isoprene (SBS/SIS), hydrogenated SBS/SIS, polyolefin derivatives such as polypropylene, polyethylene, thermoplastic polyolefin copolymers, polyvinyl chloride (PVC), biopolymers, pultruded polyester or polyurethane composites, and wood polymer composites.

12. The multilayer, dark-colored structure of claim 6, wherein said structure further comprises an intermediate high NIR reflective layer between the cap layer and the substrate layer, wherein said high NIR reflective layer comprises at least 6 weight percent of titanium dioxide.

13. A process for forming the multilayer structure of claim 6, comprising the steps of:
a) blending the components of the cap layer together,
b) applying said cap layer composition onto a substrate layer.

14. The process of claim 13, wherein said process is a coextrusion, injection molding, insert molding, pultrusion, or extrusion lamination.

15. The process of claim 13, wherein prior to step a) at least two different master batches are formed, each containing one or more dyes and a thermoplastic carrier resin, followed by combining the master batches with the matrix resin.

16. The multilayer, dark colored structure of claim 13, wherein said structure comprises an article selected from the group consisting of: automotive parts, recreational vehicles, bathtubs, shower stalls, counters, appliance housings and liners, building materials, doors, windows, siding, decking, railings, shutters, lawn and garden parts, storage containers, deck board, hand rail siding, and window profiles.
